(19) United States
(12) Patent Application Publication
(10) Pub. No.: US 2026/0343102 A1
(43) Pub. Date: Oct. 29, 2026

(54) ADAPTIVE EXPOSURE RATIO MODEL IN VIDEO SEE-THROUGH (VST) EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/548,757

(22) Filed: Feb. 24, 2026

Related U.S. Application Data
(60) Provisional application No. 63/796,979, filed on Apr. 29, 2025.

(51) Int. Cl. H04N 23/73; G06T 3/02; G06T 5/94; G06V 10/60

(52) U.S. Cl. CPC H04N 23/73; G06T 3/02; G06T 5/94; G06V 10/60; G06T 2207/20192

(57) ABSTRACT

A method includes obtaining image data including an image frame having a plurality of pixels and determining a scene lighting condition associated with the image data. The method also includes creating an exposure ratio model based on the image data and the scene lighting condition. The method further includes creating an image enhancement model using the exposure ratio model. In addition, the method includes performing an image enhancement process on the image data using the image enhancement model to produce enhanced image data and processing the enhanced image data for display on at least one display device.

### CROSS-REFERENCE TO RELATED APPLICATION AND PRIORITY CLAIM

This application claims priority under 35 U.S.C. § 119 (e) to U.S. Provisional Patent Application No. 63/796,979 filed on Apr. 29, 2025, which is hereby incorporated by reference in its entirety.

### TECHNICAL FIELD

This disclosure relates generally to imaging systems and processes. More specifically, this disclosure relates to an adaptive exposure ratio model in video see-through (VST) extended reality (XR) or other applications.

### BACKGROUND

Extended reality (XR) systems are becoming more and more popular over time, and numerous applications have been and are being developed for XR systems. Some XR systems (such as augmented reality or “AR” systems and extended reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to an adaptive exposure ratio model in video see-through (VST) extended reality (XR) or other applications.

In a first embodiment, a method includes obtaining, using at least one processing device of an electronic device, image data including an image frame having a plurality of pixels and determining, using the at least one processing device, a scene lighting condition associated with the image data. The method also includes creating, using the at least one processing device, an exposure ratio model based on the image data and the scene lighting condition. The method further includes creating, using the at least one processing device, an image enhancement model using the exposure ratio model. In addition, the method includes performing, using the at least one processing device, an image enhancement process on the image data using the image enhancement model to produce enhanced image data and processing, using the at least one processing device, the enhanced image data for display on at least one display device.

In a second embodiment, an electronic device includes at least one processing device configured to obtain image data including an image frame having a plurality of pixels and determine a scene lighting condition associated with the image data. The at least one processing device is also configured to create an exposure ratio model based on the image data and the scene lighting condition. The at least one processing device is further configured to create an image enhancement model using the exposure ratio model. In addition, the at least one processing device is configured to perform an image enhancement process on the image data using the image enhancement model to produce enhanced image data and process the enhanced image data for display on at least one display device.

In a third embodiment, a non-transitory machine readable medium contains instructions that when executed cause at least one processor of an electronic device to obtain image data including an image frame having a plurality of pixels and determine a scene lighting condition associated with the image data. The non-transitory machine readable medium also contains instructions that when executed cause the at least one processor to create an exposure ratio model based on the image data and the scene lighting condition. The non-transitory machine readable medium further contains instructions that when executed cause the at least one processor to create an image enhancement model using the exposure ratio model. In addition, the non-transitory machine readable medium contains instructions that when executed cause the at least one processor to perform an image enhancement process on the image data using the image enhancement model to produce enhanced image data and process the enhanced image data for display on at least one display device.

Any single one or any combination of the following features may be used with the disclosed embodiments.

An exposure ratio map may be creating using the exposure ratio model, where the exposure ratio map includes an exposure ratio value for each of the pixels. Edge preserving filtering may be performed on the exposure ratio map using one or more parameters of the exposure ratio model. The image enhancement process may incorporate the filtered exposure ratio map.

A camera response model may be created using one or more parameters of at least one imaging sensor used to capture the image frame and camera color calibration, a brightness transform model may be created using the one or more parameters, and the image enhancement model may be created by integrating the exposure ratio model, the camera response model, and the brightness transform model.

The exposure ratio model may be created using an illumination map and one or more parameters of at least one imaging sensor used to capture the image frame.

The image enhancement model and the exposure ratio model may be integrated to generate an integrated image enhancement model, brightness enhancement may be performed on the image data using the integrated image enhancement model, and contrast enhancement may be performed on the image data using the integrated image enhancement model.

An exposure ratio map may be created using the exposure ratio model, and the exposure ratio map may include an exposure ratio value for each of the pixels. Edge preserving filtering may be performed on the exposure ratio map using one or more parameters of the exposure ratio model, and the image enhancement process may incorporate the filtered exposure ratio map.

The edge preserving filtering may be performed by creating an illumination patch using an affine transform of a corresponding image patch, determining one or more transform parameters based on the affine transform, creating an illumination patch map using a plurality of image patches and the one or more transform parameters, and integrating the illumination patch map to generate an illumination map.

The edge preserving filtering may be performed by determining one or more parameters of the exposure ratio model for keeping a structure of the image frame and smoothing areas where intensity changes by less than a specified threshold.

The enhanced image data may be processed for display by performing one or more passthrough transformations to produce final view frames for display.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example high-level process for image enhancement using an adaptive exposure ratio model in video see-through (VST) extended reality (XR) or other applications in accordance with this disclosure;

FIG. 3 illustrates an example detailed process for image enhancement using an adaptive exposure ratio model in VST XR or other applications in accordance with this disclosure;

FIG. 4 illustrates an example process for creating and using an adaptive exposure ratio map in VST XR or other applications in accordance with this disclosure;

FIG. 5 illustrates an example process for edge preserving filtering for creating an exposure ratio map in accordance with this disclosure;

FIG. 6 illustrates an example process for image enhancement using an exposure ratio model in accordance with this disclosure; and

FIG. 7 illustrates an example method for image enhancement using an adaptive exposure ratio model in VST XR or other applications in accordance with this disclosure.

### DETAILED DESCRIPTION

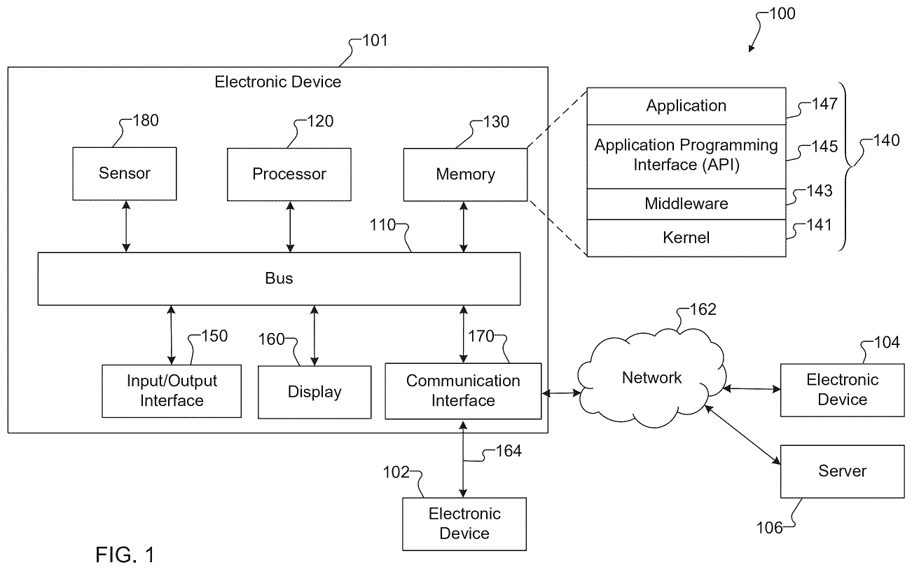

FIGS. 1 through 7, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As noted above, extended reality (XR) systems are becoming more and more popular over time, and numerous applications have been and are being developed for XR systems. Some XR systems (such as augmented reality or “AR” systems and extended reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. The visual quality of final view frames can directly affect a user's experiences with a VST XR device. The visual quality of the final view frames often depends on the visual quality of the captured image frames. Unfortunately, a typical VST headset struggles in low-light environments, generating dark frames with low brightness and contrast. Among other things, this can impair the user's ability to perceive his or her surroundings clearly, often resulting in discomfort and a negative user experience.

This disclosure provides various techniques supporting image enhancement using an adaptive exposure ratio model in VST XR or other applications. As described in more detail below, image data including an image frame having a plurality of pixels can be obtained, and a scene lighting condition associated with the image data can be determined. An exposure ratio model can be created based on the image data and the scene lighting condition, and an exposure ratio map can be created using the exposure ratio model. The exposure ratio map can include an exposure ratio value for each of the pixels. Edge preserving filtering can be performed on the exposure ratio map using one or more parameters of the exposure ratio model, and an image enhancement model can be created using the exposure ratio model. An image enhancement process can be performed on the image data using the image enhancement model to produce enhanced image data, and the enhanced image data can be processed for display.

In this way, the disclosed techniques can improve the visual quality of generated final view frames before the final view frames are presented to users. For example, the disclosed techniques can create an adaptive exposure ratio model from an image illumination map, integrating the adaptive exposure ratio model into an image quality enhancement model with camera color models, and enhance final view images with the image quality enhancement model. After image enhancement, the final view frame images may have better brightness and contrast, which often makes a user feel more comfortable while using a VST XR device or other device.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to image enhancement using an adaptive exposure ratio model in VST XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform image enhancement using an adaptive exposure ratio model in VST XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit (IMU) that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to image enhancement using an adaptive exposure ratio model in VST XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

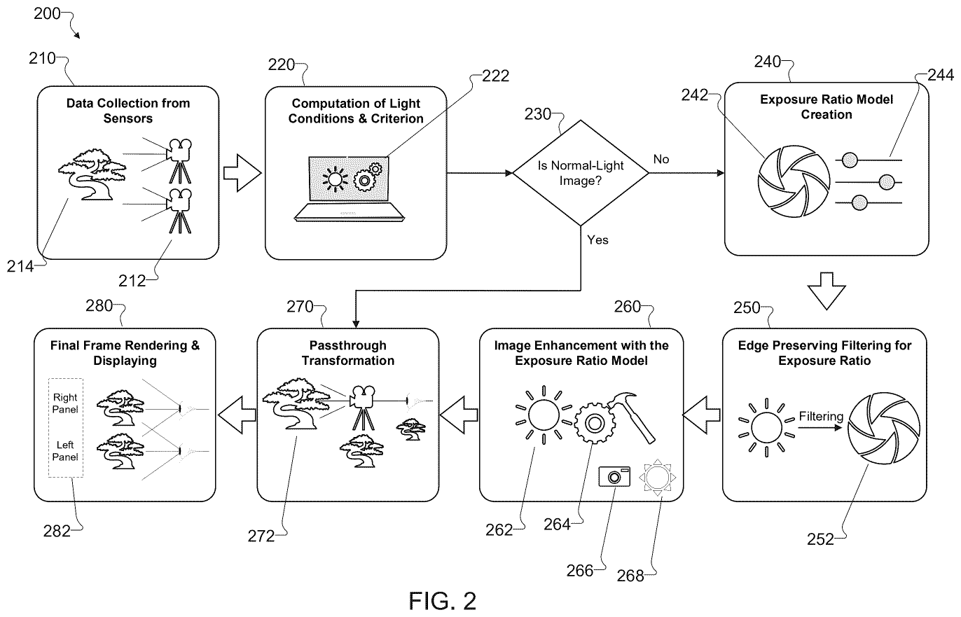

FIG. 2 illustrates an example high-level process 200 for image enhancement using an adaptive exposure ratio model in VST XR or other applications in accordance with this disclosure. For ease of explanation, the process 200 of FIG. 2 is described as being implemented using the electronic device 101 in the network configuration 100 of FIG. 1. However, the process 200 may be implemented using any other suitable device(s) (such as the server 106) and in any other suitable system(s).

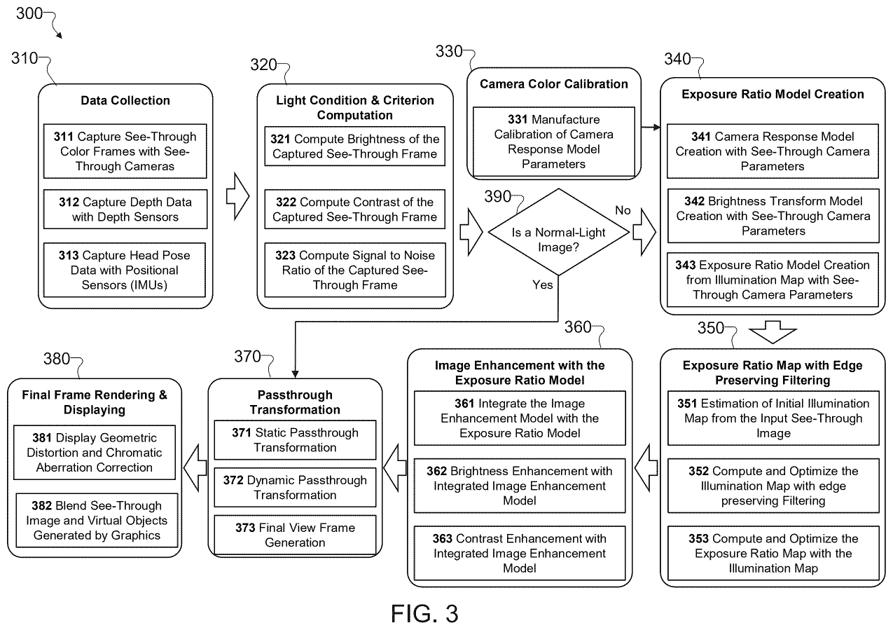

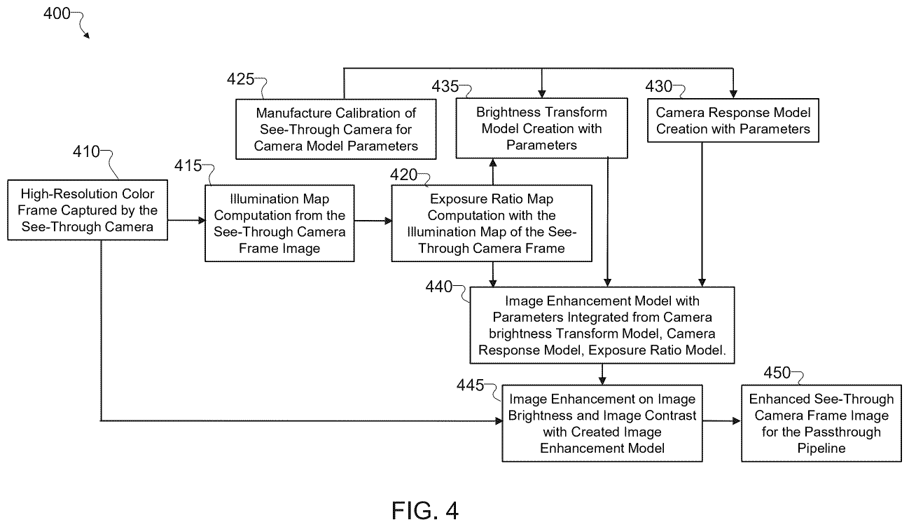

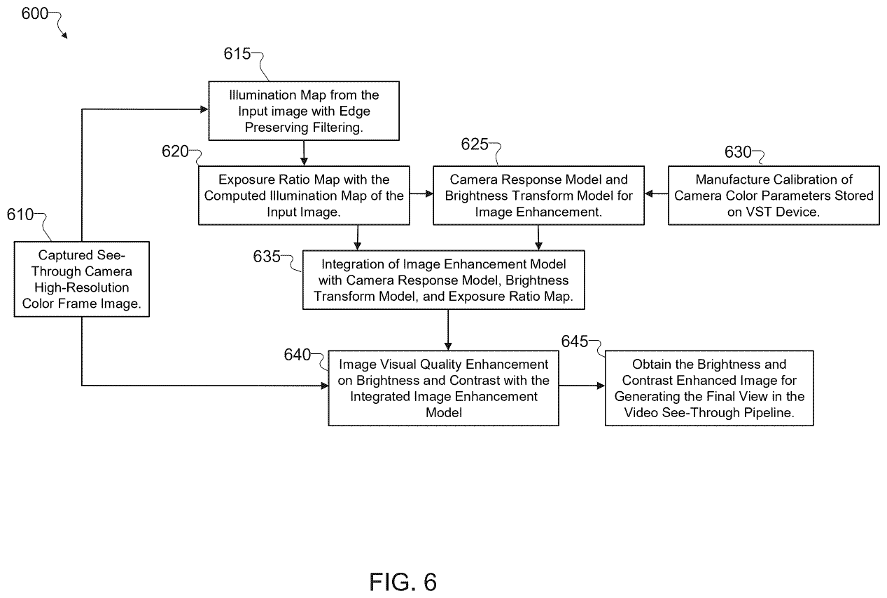

As shown in FIG. 2, the process 200 collects input image data 212 of a scene at step 210. For example, the electronic device 101 may collect this image data by receiving see-through color frames from one or more see-through cameras or other imaging sensors 180, receiving depth data from one or more depth sensors 180, and receiving head pose data from one or more positional sensors 180. In some cases, collecting the image data 212 can include collecting illumination data from one or more illumination sensors 180. Also, in some cases, raw imaging sensor data may undergo one or more processes, such as demosaicing, defective pixel correction, auto white balance initialization, temporal noise estimation, and lens shading correction, before further analysis. Further, in some cases, illumination data may be collected from one or more illumination sensors or inferred from captured image frames themselves. Step 210 relates generally to, for example, steps 310-313 of FIG. 3, step 410 of FIG. 4, and step 610 of FIG. 6, which are discussed below.

One or more lighting conditions 222 for the scene are determined at step 220. For example, the electronic device 101 may compute brightness and contrast of the image data for a current see-through image frame and create one or more criteria to determine an image visual quality of the current image frame. The brightness and contrast information, as well as the one or more criteria, may be included in lighting conditions 222. In some implementations, lighting conditions may include one or more per-frame histograms, percentile luminance, one or more signal-to-noise ratio (SNR) estimates from sensor gain/ISO metadata, and/or dynamic range utilization. In some cases, one or more of these lighting conditions may be derived, for example, from the same inputs used at steps 321-323 of FIG. 3.

A determination is made whether the image data represents a normal-light image that is neither too bright nor too dim and noisy for suitable image visual quality at step 230. For example, the electronic device 101 may determine whether the image data is acceptable based on the lighting conditions 222 and/or other factors, such as noise in the image data.

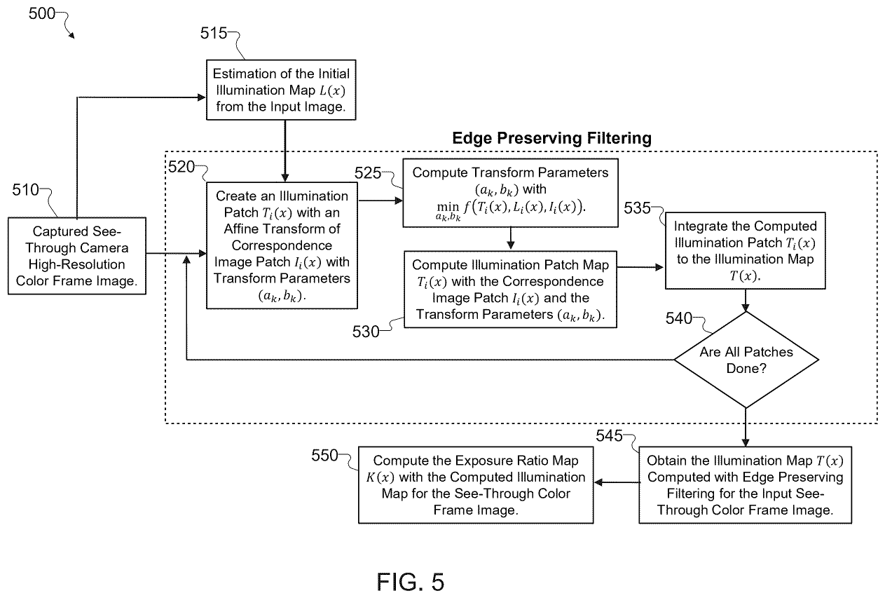

If a determination is made that the image data does not represent a normal light image, image enhancement can be performed with image brightness and contrast improvements during steps 240-260. For example, during step 240, the electronic device 101 can create an exposure ratio model 242 and use the exposure ratio model 242 to generate an exposure ratio map 244. The exposure ratio map 244 may describe or identify an exposure ratio at each pixel of the input image data. In some embodiments, the exposure ratio map 244 can be represented as a set of ratio values, where each ratio value corresponds to an individual pixel of an image frame and identifies a ratio between the brightness of that pixel and the brightest (most-exposed) pixel in the frame. Among other things, the exposure ratio map 244 could be used to analyze and control brightness and contrast of each pixel locally. As detailed in the processes of FIGS. 4 and 5 below, an illumination map may be estimated and refined using edge-preserving filtering as part of this step.

During step 250, the electronic device 101 can perform edge-preserving filtering to determine the parameters 252 of an exposure ratio model. The exposure ratio model can be used to keep the structure of an original image frame while smoothing areas in which intensity does not change significantly (such as where intensity changes by less than a specified threshold). During step 260, the electronic device 101 can perform image enhancement to improve image visual quality of the input image data and produce enhanced image data 262. In some cases, the image enhancement can include creating an image enhancement model 264, such as by integrating the exposure ratio model with a camera response model 266 and a brightness transform model 268. The image enhancement model 264 can be applied to image frames in order to perform the image enhancement of the image frames. Among other things, the image enhancement can apply the integrated image enhancement model (which may combine the exposure ratio model with the camera response model and the brightness transform model) to adjust per-pixel brightness and local contrast with tone mapping while maintaining color fidelity using calibrated camera parameters.

Final view frames are generated with passthrough transformations, which may include one or more static transformations and one or more dynamic transformations, at step 270. Depending on the circumstances, the passthrough transformations may be performed on the image frames without enhancement (for normal-light image frames) or on enhanced image frames (for other than normal-light image frames). The final view frames can be rendered and displayed, such as on one or more displays 282 (which may represent one or more displays 160) at step 280.

Although FIG. 2 illustrates one example of a high-level process 200 for image enhancement using an adaptive exposure ratio model in VST XR or other applications, various changes may be made to FIG. 2. For example, various operations or functions in FIG. 2 may be combined, further subdivided, replicated, omitted, or rearranged and additional operations or functions may be added according to particular needs. Also, different portions of the process 200 could be performed using different devices, such as when one or more operations are performed by a first electronic device (like an HMD) and one or more other operations is performed offline by a second electronic device, such as to determine or configure camera parameters or to perform camera color calibration, or before the first electronic device is deployed.

FIG. 3 illustrates an example detailed process 300 for image enhancement using an adaptive exposure ratio model in VST XR or other applications in accordance with this disclosure. For ease of explanation, the process 300 of FIG. 3 is described as being implemented using the electronic device 101 in the network configuration 100 of FIG. 1. However, the process 300 may be implemented using any other suitable device(s) (such as the server 106) and in any other suitable system(s). Also, the process 300 may represent a specific implementation of the process 200 of FIG. 2. While the process 300 includes a number of actions that are useful for illustrating this specific embodiment, they are not necessary for all implementations of the process 200.

As shown in FIG. 3, the process 300 includes data collection at step 310. For example, as part of the data collection, the electronic device 101 may capture image data, such as see-through color image frames or other image frames with one or more see-through cameras or other imaging sensors 180, at step 311. The electronic device 101 can capture depth data with one or more depth sensors 180 at step 312. Among other things, depth data can be used to guide edge-aware operations and reprojection in later processes, such as during steps 520-535 of FIG. 5 and steps 371-373 below. The electronic device 101 can capture head pose data with one or more positional sensors, such as one or more IMUs, at step 313.

The process 300 also includes light condition and criterion computation at step 320. For example, as part of the light condition and criterion computation, the electronic device 101 can determine one or more lighting conditions, such as by determining the brightness of each captured image frame at step 321. The electronic device 101 can also determine the contrast of each captured image frame at step 322. The electronic device 101 can further determine an SNR of each captured image frame at step 323.

The electronic device 101 can determine, based on the lighting condition(s), whether the image data represents a normal-light image at step 390. When the image data represents a normal-light image, the electronic device 101 can perform passthrough transformation at step 370 and final rendering at step 380, which are described in more detail below. When the image data represents an other-than-normal-light image, the electronic device 101 can perform image enhancement to improve brightness and contrast as further described in steps 340-360.

The electronic device 101 here can perform or have access to the results of a camera color calibration process at step 330. The calibration process can involve the identification of imaging sensor parameters, such as one or more parameters for each of the imaging sensors 180. For example, the imaging sensor parameters may identify how scene irradiance may translate to image brightness or intensity for each imaging sensor 180.

During step 340, the electronic device 101 can create an exposure ratio model. For example, as a part of exposure ratio model creation, the electronic device 101 can create a camera response model with see-through camera parameters at step 341, such as based on the parameters identified by the camera color calibration at step 330. Each camera response model may define a mapping of scene irradiance to image intensity based on the associated imaging sensor 180. The electronic device 101 can also create a brightness transform model with see-through camera parameters at step 342, such as based on the parameters identified by the camera color calibration at step 330. Each brightness transform model may define a mapping of scene irradiance to image brightness based on the associated imaging sensor 180. The electronic device 101 can create an exposure ratio model from an initial illumination map with see-through camera parameters at step 343. The initial illumination map could be estimated from the image data and subsequently further refined as described below. Here, the exposure ratio model can be based on the image data of the image frames being processed and the scene lighting condition(s) associated with the image frames.

During step 350, the electronic device 101 can create an exposure ratio map using edge preserving filtering. For example, as a part of exposure ratio map creation, with edge preserving filtering, the electronic device 101 can use an initial illumination map for each input see-through image frame at step 351. The electronic device 101 can compute and optimize the illumination map with edge preserving filtering at step 352, and the electronic device 101 can compute and optimize the exposure ratio map with the illumination map at step 353. The optimization may employ local affine fits guided by the image frames to preserve edges while smoothing low-texture regions as detailed in FIG. 5, such as with respect to steps 520-535.

In some cases, an exposure ratio model can describe the exposure ratio for individual pixels of an input image frame and could be computed for each image frame in a VST XR or other pipeline. This allows the exposure ratio model to describe the light environment and exposure for each individual frame. Also, in some cases, an exposure ratio map can represent a concrete pixel-level output of the exposure ratio model, such as a set of ratio values in which each ratio value corresponds to an individual pixel of an image frame. The exposure ratio map can enable the system to (if needed or desired) modify brightness and contrast of each pixel locally. By creating an exposure ratio map using edge-preserving filtering, the electronic device 101 may detect and preserve edge boundaries, such as between foreground and background portions of image data. In various embodiments, an exposure ratio model provides a mathematical and parametric framework, such as by incorporating illumination estimation, camera response characteristics, and edge-preserving filtering parameters, and the exposure ratio map represents a per-pixel numerical output derived from that model that could be directly applied during image enhancement.

During step 360, the electronic device 101 can perform image enhancement with the exposure ratio model. For example, as part of image enhancement, the electronic device 101 can integrate the image enhancement model with the exposure ratio model at step 361. The electronic device 101 can perform brightness enhancement for one or more input image frames with the integrated image enhancement model at step 362. The electronic device 101 can perform contrast enhancement for one or more input image frames with the integrated image enhancement model at step 363.

During the passthrough transformation at step 370, the electronic device 101 can perform static transformations at step 371, such as by applying transformations to distortion meshes and applying the distortion meshes to the image frames. The electronic device 101 can also perform dynamic transformations at step 372 on each of the image frames. The electronic device 101 can generate final view frames based on the static and dynamic transformations from the captured image frames at step 373.

A static transformation may not depend on the contents of the image frames being processed and could be based on the components of the electronic device 101 and/or the configuration of the components of the electronic device 101. A dynamic transformation can vary based on the contents of the image frames being processed.

In some cases, the static transformations can include a camera undistortion transformation and/or an HMD geometric transformation. A camera undistortion transformation can be used to correct for lens distortions in captured image frames caused by one or more lenses of one or more imaging sensors 180 used to capture the image frames. An HMD geometric transformation can be used to correct for distortions caused by the layout and arrangement of the imaging sensors 180 relative to the user's eyes, such as when the imaging sensors 180 are not positioned directly in front of the user's eyes. Also, in some cases, the dynamic transformations can include a time warp reprojection, a planar reprojection, or a depth-based reprojection. A time warp reprojection generally refers to a reprojection of image data from one image frame to another, where the image data is generally within a common plane in both image frames. A planar reprojection generally refers to a reprojection of image data onto a single plane, such as when all background image content is reprojected to a single plane at a single specified depth from the electronic device 101. A depth-based reprojection generally refers to a reprojection of image data based on depths associated with the image data. Each of these transformations (or a combination of two or more of these transformations) may be implemented in any suitable manner, such as by warping or otherwise modifying the image frames or rendering meshes associated with the image frames to achieve the desired correction(s).

As part of the final rendering at step 380, the electronic device 101 can perform display lens geometric distortion and chromatic aberration correction at step 381. For example, the electronic device 101 can pre-compensate image frames for expected geometric distortions and chromatic aberrations created when rendered images are displayed and viewed through display lenses of the electronic device 101. This allows the electronic device 101 to provide final views with correct shapes and colors to the user. The electronic device 101 can also blend image frames and one or more virtual objects and render the resulting images to one or more display panels at step 382.

Although FIG. 3 illustrates one example of a detailed process 300 for image enhancement using an adaptive exposure ratio model in VST XR or other applications, various changes may be made to FIG. 3. For example, various operations or functions in FIG. 3 may be combined, further subdivided, replicated, omitted, or rearranged and additional operations or functions may be added according to particular needs. Also, different portions of the process 300 could be performed using different devices, such as when one or more operations are performed by a first electronic device (like an HMD) and one or more other operations is performed offline by a second electronic device, such as to determine or configure camera parameters or to perform camera color calibration, or before the first electronic device is deployed.

Note that in the processes 200 and 300, an illumination map can be determined using an input image frame with edge preserving filtering, and an exposure ratio model can be determined with the illumination map. However, the illumination map could be determined in any other suitable manner, such as by using iterative approaches or analytical solutions of a quadratic equation. With the determined illumination map, the exposure ratio model can be determined, the image enhancement model can be generated with the exposure ratio model, and image visual quality enhancement can be performed. Also note that image visual quality enhancement is performed in the processes 200 and 300 before final view generation with passthrough transformation. In other cases, image visual quality enhancement can be performed using the image enhancement model after final view generation with passthrough transformation.

FIG. 4 illustrates an example process 400 for creating and using an adaptive exposure ratio map in VST XR or other applications in accordance with this disclosure. For ease of explanation, the process 400 of FIG. 4 is described as being implemented using the electronic device 101 in the network configuration 100 of FIG. 1. However, the process 400 may be implemented using any other suitable device(s) (such as the server 106) and in any other suitable system(s). Also, the process 400 may represent a specific implementation of certain steps of the process 200 of FIG. 2 and/or the process 300 of FIG. 3. While the process 400 includes a number of actions that are useful for illustrating this specific embodiment, they are not necessary for all implementations of the process 200 or 300.

As shown in FIG. 4, the electronic device 101 can obtain image data including one or more high-resolution color frame images at step 410. This can be performed, for example, using at least one see-through camera or other imaging sensor(s) 180. The electronic device 101 can compute an illumination map T(x) from the image data at step 415, such as by generating an illumination map for each high-resolution color image frame. The electronic device 101 can compute an exposure ratio map K(x) using the illumination map for each high-resolution color frame image at step 420. The generation of the exposure ratio map K(x) may generally correspond to steps 351-353 of FIG. 3 and step 620 of FIG. 6. In some cases, the electronic device 101 can create an exposure ratio model and an exposure ratio map K(x) with the illumination map T(x). In some embodiments, the exposure ratio map K(x) can be defined as follows.

$$K ( x ) = \frac{1}{max ( T ( x ) , ε )}$$

Here, ε may represent a small number to avoid overflow.

The electronic device 101 can create a camera response model R(E(x)), such as by using a Sigmoid function, at step 430. In some embodiments, the camera response model can be defined as follows.

$$ℛ ( E ( x ) ) = ( 1 + α ) \frac{{E ( x )}^{β}}{{E ( x )}^{β} + α}$$

Here, E(x) represents image irradiance, and (α,β) represents camera parameters. In some cases, the camera parameters (α,β) may be obtained as a result of camera manufacturer calibration at step 425. The electronic device 101 can also create a brightness transform model B(I(x), K(x)), such as by using a Sigmoid function, at step 435. In some embodiments, the brightness transform model B(I(x), K(x)) can be expressed as follows.

$$ℬ ( I ( x ) , K ( x ) ) = \frac{{K ( x )}^{β} I ( x ) ( 1 + α )}{( {K ( x )}^{β} - 1 ) I ( x ) + 1 + α}$$

Here, K(x) represents an exposure ratio map, and I(x) represents an image frame. As shown here, the camera response model can depend on camera properties with parameters (α,β), and the brightness transform model can depend on both camera properties and light environment of each captured image frame.

The electronic device 101 can create an image enhancement model at step 440 based on the brightness transform model, the camera response model, and exposure ratio model and/or the exposure ratio map. In some cases, for example, the electronic device 101 could integrate parameters from the brightness transform model, the camera response model, and exposure ratio model and/or the exposure ratio map into a single model. The electronic device 101 can perform image visual quality enhancement for each image frame at step 445. For example, the image enhancement can be performed on image brightness and image contrast using the image enhancement model. Enhancement can include processes such as per-pixel brightness scaling by K(x) (thereby incorporating the exposure ratio map, which may have been processed using edge preserving filtering), local contrast expansion (like bilateral or edge-aware tone mapping), and color preservation. The enhancement here can correspond to the enhancement performed in steps 361-363 of FIG. 3 or steps 635-645 of FIG. 6. The electronic device 101 can deliver the resulting enhanced image frame image for passthrough transformation at step 450.

Note that the exposure ratio model created at step 420 may describe exposure ratios for individual pixels of the input image. The image enhancement model created using the exposure ratio model can adjust brightness and contrast for individual pixels. Since the exposure ratio model could be computed for each image frame in a video see-through pipeline, the model can describe the light environment and exposure for each individual frame. As a result, the image enhancement model can adaptively improve image visual quality for each pixel in each frame. This provides a distinct technical advantage compared to other approaches in that the processes described here can adaptively improve image visual quality by fitting different image capturing environments.

Although FIG. 4 illustrates one example of a process 400 for creating and using an adaptive exposure ratio map in VST XR or other applications, various changes may be made to FIG. 4. For example, various operations or functions in FIG. 4 may be combined, further subdivided, replicated, omitted, or rearranged and additional operations or functions may be added according to particular needs. Also, different portions of the process 400 could be performed using different devices, such as when one or more operations are performed by a first electronic device (like an HMD) and one or more other operations is performed offline by a second electronic device, such as to determine or configure camera parameters or to perform camera color calibration, or before the first electronic device is deployed.

FIG. 5 illustrates an example process 500 for edge preserving filtering for creating an exposure ratio map in accordance with this disclosure. For ease of explanation, the process 500 of FIG. 5 is described as being implemented using the electronic device 101 in the network configuration 100 of FIG. 1. However, the process 500 may be implemented using any other suitable device(s) (such as the server 106) and in any other suitable system(s). Also, the process 500 may represent a specific implementation of certain steps of the process 200 of FIG. 2 and/or the process 300 of FIG. 3. While the process 500 includes a number of actions that are useful for illustrating this specific embodiment, they are not necessary for all implementations of the process 200 or 300.

As shown in FIG. 5, the electronic device 101 can receive a high-resolution see-through color frame at step 510, which may occur as described above. For example, the image frame may be obtained as part of image data captured by one or more imaging sensors 180. The electronic device 101 can estimate an initial illumination map L (x) from the captured image frame at step 515. The initial illumination mapL(x) could be computed using any number of different approaches, such as max-RGB, gray-world, or Retinex-inspired strategies that approximate scene illumination prior to edge-preserving refinement. In some cases, the electronic device 101 can estimate an initial illumination mapL(x) from the input image I(x), such as in the following manner.

L(x)=max(I(R),I(G),I(B))

Here, I(R), I(G), and I(B) represent red channel, green channel, and blue channel image data, respectively, for an image frame.

The electronic device 101 can create an illumination patch Tᵢ(x) with affine transform of a correspondence image patch Iᵢ(x) with transform parameters (aₖ, bₖ) at step 520. In some cases, overlapping patches can be used in different iterations through the process 500 to reduce blocking artifacts, and guidance can be taken from the original image frame to align edges in T(x) with edges in I(x). In some cases, the electronic device 101 can refine the illumination map T(x) from the initial estimationL(x) using edge-preserving filtering with guidance of the input image I(x). To do so, the electronic device 101 can process a small, segmented patch of the illumination map Tᵢ(x) as an affine transform of corresponding image patch Iᵢ(x) in the RGB space. This could be expressed as follows.

Tᵢ(x)=aₖlᵢ(x)+bₖ,i∈wₖ

Here, aₖ, bₖ represent the affine transform coefficients for the patch centered at pixel k, and both may be constant in a patch window of size wₖ. Also, Iᵢ(x) represents the input guidance image, and Tᵢ(x) represents the output illumination map value.

The electronic device 101 can compute transform parameters (aₖ, bₖ) of each illumination patch with a minimization process at step 525. In some cases, to determine the coefficients aₖ and bₖ for each image patch, the electronic device 101 could apply an optimization target function, such as one expressed in the following manner.

$${min}_{{a}_{k} , {b}_{k}} {E}_{k} = arg {min}_{{a}_{k} , {b}_{k}} {\sum }_{k} {\sum }_{i ∈ {w}_{k}} {( {T}_{i} ( x ) - {L}_{i} ( x ) )}^{2} + ε {a}_{k}^{2}$$

Here, Lᵢ(x) represents an input initial illumination value at pixel i,

$$ε {a}_{k}^{2}$$

represents a regulation term that prevents aₖ from getting too large, and ε represents a parameter that controls the regularization effect. This function can also be expressed as follows.

$${min}_{{a}_{k} , {b}_{k}} {E}_{k} = arg {min}_{{a}_{k} , {b}_{k}} {\sum }_{k} {\sum }_{i ∈ {w}_{k}} {( {a}_{k} {I}_{i} ( x ) + {b}_{k} - {L}_{i} ( x ) )}^{2} + ε {a}_{k}^{2}$$

Here, Iᵢ(x) represents the input guidance image value at pixel i, and Lᵢ(x) represents an input initial illumination value at pixel i. In some cases, this function can be solved as follows.

$$\{ \begin{matrix}{a}_{k} = \frac{{\sum }_{i ∈ {w}_{k}} ( {L}_{i ( x )} {I}_{i} ( x ) - {\tilde{L}}_{k} ( x ) {I}_{i} ( x ) )}{{\sum }_{i ∈ {w}_{k}} ( {I}_{i}^{2} ( x ) - {\tilde{I}}_{k} ( x ) {I}_{i} ( x ) ) + ε} \\ {b}_{k} = {\tilde{p}}_{k} ( x ) - {a}_{k} {\tilde{I}}_{k} ( x )\end{matrix}$$

Here, Ĩₖ(x), \tilde{L}ₖ(x) represent the average of the guidance image patch and illumination map patch centered at pixel k, respectively.

The electronic device 101 can compute an illumination patch map Tᵢ(x) with the correspondence image patch Iᵢ(x) with transform parameters (aₖ, bₖ) at step 530. For example, the same pixel could be included in multiple patches, and the final output illumination map value Tᵢ(x) could be calculated as an average of the filtering output from all patches with which the pixel has been involved. In some cases, this can be expressed as follows.

$${T}_{i} ( x ) = \frac{1}{\vert {wn}_{i} \vert} {\sum }_{k , i ∈ {w}_{k}} ( {a}_{k} {I}_{i} ( x ) + {b}_{k} )$$

Here, |wnᵢ| represents the number of patches that includes pixel i. The electronic device 101 can integrate the computed illumination patch Tᵢ(x) into the illumination map T(x) at step 535. For example, the computed illumination patch Tᵢ(x) can be included in the illumination map T(x) being constructed.

The electronic device 101 can determine whether all illumination patches are completed and integrated into the illumination map T(x) at step 540. If not, the electronic device 101 can return to step 520 and repeat the various steps 520-540 until all illumination patches are completed and integrated into the illumination map T(x). Once completed, the electronic device 101 stores the completed illumination map T(x) at step 545. Using this process, the illumination map T(x) can be created using edge-preserving filtering (illustrated at steps 520-535) for the image frame as described in more detail below.

The electronic device 101 can compute an exposure ratio map K(x) using the computed illumination map T(x) for the image frame at step 550. For example, the electronic device 101 could compute individual exposure ratio map values Kᵢ(x) in the exposure ratio map as follows.

$${K}_{i} ( x ) = \frac{1}{max ( {T}_{i} ( x ) , ε )}$$

A small value ε here can help to guard against division by near-zero. Also, optional smoothing of K(x) can mitigate halos when applying per-pixel gain during enhancement.

Although FIG. 5 illustrates one example of a process 500 for edge preserving filtering for creating an exposure ratio map, various changes may be made to FIG. 5. For example, various operations or functions in FIG. 5 may be combined, further subdivided, replicated, omitted, or rearranged and additional operations or functions may be added according to particular needs. Also, different portions of the process 500 could be performed using different devices, such as when one or more operations are performed by a first electronic device (like an HMD) and one or more other operations is performed offline by a second electronic device, such as to determine or configure camera parameters or to perform camera color calibration, or before the first electronic device is deployed.

FIG. 6 illustrates an example process 600 for image enhancement using an exposure ratio model in accordance with this disclosure. For ease of explanation, the process 600 of FIG. 6 is described as being implemented using the electronic device 101 in the network configuration 100 of FIG. 1. However, the process 600 may be implemented using any other suitable device(s) (such as the server 106) and in any other suitable system(s). Also, the process 600 may represent a specific implementation of certain steps of the process 200 of FIG. 2 and/or the process 300 of FIG. 3. While the process 600 includes a number of actions that are useful for illustrating this specific embodiment, they are not necessary for all implementations of the process 200 or 300.

As shown in FIG. 6, the electronic device 101 can receive a high-resolution see-through color frame at step 610, which may occur as described above. For example, the image frame may be obtained as part of image data captured by one or more imaging sensors 180. The electronic device 101 can create an illumination map from the input image data using edge preserving filtering at step 615. This process can transfer structure from the input image data to the illumination map, smooth non-feature areas, and preserve edge features. In some embodiments, the refinement can reuse the local affine patch fitting and aggregation, such as described for steps 520-535 of FIG. 5 and step 352 of FIG. 3.

The electronic device 101 can create an exposure ratio map using the illumination map of the image data at step 620. In some embodiments, the exposure ratio map K(x) can be computed from the illumination map T(x) as described above, such as with reference to the exposure ratio map computation described at step 420 of FIG. 4 and/or step 550 of FIG. 5. Each value in the exposure ratio map could correspond to an individual pixel and may represent the ratio between that pixel's brightness and the brightest (most-exposed) pixel in the frame. The exposure ratio map can be used to adjust pixel brightness and contrast individually for local image visual quality enhancement.

The electronic device 101 can create a camera response model and a brightness model using the exposure ratio map at step 625. For example, manufacturer-calibrated parameters (such as α, β, CCMs, and tone curves) and scene statistics (such as histogram percentiles) may be used when determining brightness transforms to avoid clipping and maintain color constancy. In some cases, the camera response model R(E(x)) and brightness transform model B(I(x), K(x)) can be expressed using Sigmoid functions. In some embodiments, these models can be created as described above, such as with reference to steps 341-342 of FIG. 3 and/or steps 430-435 of FIG. 4.

The electronic device 101 can incorporate one or more camera properties calibrated from or by the manufacturer, such as through an offline calibration process performed during manufacture or an online calibration process performed during device operation, into the camera response model at step 630. This calibration can typically include, for example, determination of the camera response model parameters that characterize the sensor's response characteristics. The calibration process can also include the identification of spectral characterizations, white balance gains, color correction matrices, and/or lens shading profiles. In some embodiments, this process can incorporate information about the scene light environment acquired during image capture, such as brightness, contrast, and SNR as computed during steps 321-323 of FIG. 3. In some cases, the incorporation of the one or more camera properties may occur as described above, such as with reference to steps 330 and 336 of FIG. 3 and/or step 425 of FIG. 4. By combining manufacturer-calibrated camera parameters with scene-specific lighting information, the camera response model can accurately characterize image formation and enable appropriate brightness and contrast adjustments during image enhancement.

The electronic device 101 can integrate the image enhancement model with the camera response model, the brightness transform model, and the exposure ratio model at step 635. Integration may be realized, for example, as a per-pixel pipeline that applies K(x) in a linear color space, followed by tone mapping and color correction, with spatial regularization to suppress amplification of sensor noise. The exposure ratio model and brightness transform model can be computed from and/or correspond to the current frame of the image data. The electronic device 101 can perform image visual quality enhancement on brightness and contrast using the image enhancement model at step 640. For example, using the image enhancement model, the electronic device 101 can adjust the visual quality for each pixel of the input image and make brightness consistent in the whole image. The electronic device 101 can produce a brightness- and contrast-enhanced image at step 645, such as by generating a final view in the pipeline such that the user can perceive the captured environment.

Although FIG. 6 illustrates one example of a process 600 for image enhancement using an exposure ratio model, various changes may be made to FIG. 6. For example, various operations or functions in FIG. 6 may be combined, further subdivided, replicated, omitted, or rearranged and additional operations or functions may be added according to particular needs. Also, different portions of the process 600 could be performed using different devices, such as when one or more operations are performed by a first electronic device (like an HMD) and one or more other operations is performed offline by a second electronic device, such as to determine or configure camera parameters or to perform camera color calibration, or before the first electronic device is deployed.

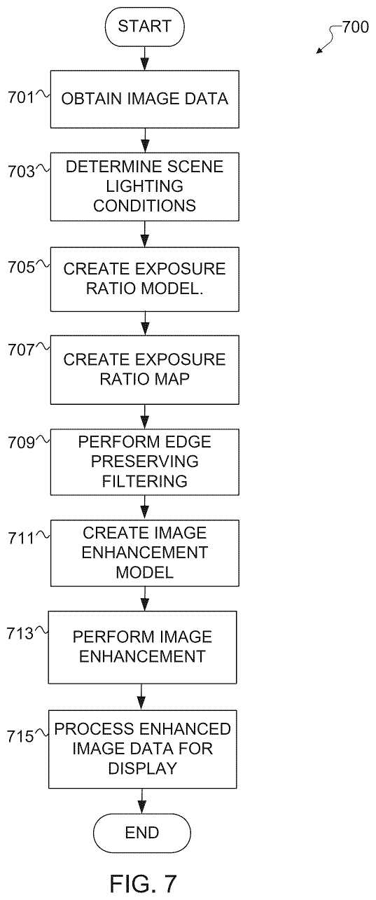

FIG. 7 illustrates an example method 700 for image enhancement using an adaptive exposure ratio model in VST XR or other applications in accordance with this disclosure. For ease of explanation, the method 700 of FIG. 7 is described as being implemented using the electronic device 101 in the network configuration 100 of FIG. 1. However, the method 700 may be implemented using any other suitable device(s) (such as the server 106) and in any other suitable system(s).

As shown in FIG. 7, image data including an image frame captured using at least one imaging sensor is obtained at step 701. This may include, for example, the processor 120 of the electronic device 101 performing the data collection described at step 210 of FIG. 2 and/or steps 310-313 of FIG. 3. This may optionally include preprocessing image data, such as by performing demosaicing and white balance initialization. The image frame includes a plurality of pixels. One or more scene lighting conditions associated with the image data are determined at step 703. This may include, for example, the processor 120 of the electronic device 101 determining brightness, contrast, and SNR of the image data.

An exposure ratio model is created based on the image data and the scene lighting condition(s) at step 705. This may include, for example, the processor 120 of the electronic device 101 creating an exposure ratio model using an illumination map and one or more camera parameters of at least one imaging sensor 180. In some embodiments, the exposure ratio model may be generated by performing steps 340-343 of FIG. 3 and/or steps 415-420 of FIG. 4. An exposure ratio map is created using the exposure ratio model at step 707. This may include, for example, the processor 120 of the electronic device 101 generating an exposure ratio map identifying an exposure ratio value for each of the plurality of pixels in the image frame.

Edge preserving filtering is performed on the exposure ratio map using one or more parameters of the exposure ratio model at step 709. This may include, for example, the processor 120 of the electronic device 101 creating illumination patches using an affine transform of corresponding image patches, computing transform parameters based on the affine transform, creating illumination patch maps using a plurality of image patches and the transform parameters, and integrating the illumination patch maps into an illumination map. In some cases, the edge preserving filtering may be performed by performing steps 520-535 of FIG. 5 and/or step 352 of FIG. 3. In some cases, performing the edge preserving filtering can include computing one or more parameters of the exposure ratio model for keeping a structure of the image frame and smoothing areas where an intensity does not change significantly (such as areas where intensity changes by less than a specified threshold).

An image enhancement model is created using the exposure ratio model at step 711. This may include, for example, the processor 120 of the electronic device 101 performing various processes as described above, such as creating a camera response model using one or more camera parameters of the imaging sensor 180 and camera color calibration and creating a brightness transform model using the camera parameters. In some cases, the image enhancement model could be created by integrating the exposure ratio model, the camera response model, and/or the brightness transform model.

An image enhancement process is performed on the image data using the image enhancement model to produce enhanced image data at step 713. This may include, for example, the processor 120 of the electronic device 101 performing brightness enhancement on the image data using the integrated image enhancement model and/or contrast enhancement on the image data using the integrated image enhancement model. In some cases, the image enhancement may be performed by performing step 260 of FIG. 2, steps 361-363 of FIG. 3, steps 440-445 of FIG. 4, and/or steps 535-545 of FIG. 5.

The enhanced image data is processed for display on at least one display device at step 715. This may include, for example, the processor 120 of the electronic device 101 performing one or more passthrough transformations to produce one or more final view frames for display and rendering the final view frame(s). This may also include the processor 120 of the electronic device 101 sending the final view frame(s) to one or more display devices and/or initiating display of the final view frame(s). In some cases, the enhanced image data may be processed by performing steps 270-280 of FIG. 2 and/or steps 370-382 of FIG. 3.

Although FIG. 7 illustrates one example of an integrated method 700 for image enhancement using an adaptive exposure ratio model in VST XR or other applications, various changes may be made to FIG. 7. For example, while shown as a series of steps, various steps in FIG. 7, or any of the processes described herein, could overlap, occur in parallel, occur in a different order, or occur any number of times (including zero times).

The processes and techniques disclosed here can be applied in any number of contexts to provide significant technical advantages. For example, the processes and techniques disclosed here can be used for image quality enhancement in VST XR applications, such as to efficiently create an image visual enhancement model with a camera color model, a brightness model, and an exposure ratio model. This can help to improve image visual quality obtained using the image enhancement model. As another example, the processes and techniques described here can be used to create a camera exposure ratio model for low-light imaging in VST XR or other applications, which can provide advantages in low-light imaging processing. Such implementations may include computing an illumination map from an input image frame, creating an exposure ratio map from the illumination map to model the capturing environment of the input image, and using the exposure ratio model for adjusting the brightness and contrast of individual pixels in the input image frame. As yet another example, the processes and techniques described here can be used for image visual quality improvement in general image processing. By modeling a lighting environment, disclosed embodiments can create an exposure ratio model and image enhancement model to improve image visual quality.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, image data including an image frame having a plurality of pixels;
determining, using the at least one processing device, a scene lighting condition associated with the image data;
creating, using the at least one processing device, an exposure ratio model based on the image data and the scene lighting condition;
creating, using the at least one processing device, an image enhancement model using the exposure ratio model;
performing, using the at least one processing device, an image enhancement process on the image data using the image enhancement model to produce enhanced image data; and
processing, using the at least one processing device, the enhanced image data for display on at least one display device.

2. The method of claim 1, further comprising:
creating a camera response model using one or more parameters of at least one imaging sensor used to capture the image frame and camera color calibration; and
creating a brightness transform model using the one or more parameters;
wherein the image enhancement model is created by integrating the exposure ratio model, the camera response model, and the brightness transform model.

3. The method of claim 1, wherein the exposure ratio model is created using an illumination map and one or more parameters of at least one imaging sensor used to capture the image frame.

4. The method of claim 1, further comprising:
integrating the image enhancement model and the exposure ratio model to generate an integrated image enhancement model;
performing brightness enhancement on the image data using the integrated image enhancement model; and
performing contrast enhancement on the image data using the integrated image enhancement model.

5. The method of claim 1, further comprising:
creating an exposure ratio map using the exposure ratio model, the exposure ratio map including an exposure ratio value for each of the pixels; and
performing edge preserving filtering on the exposure ratio map using one or more parameters of the exposure ratio model, wherein the image enhancement process incorporates the filtered exposure ratio map.

6. The method of claim 5, wherein performing the edge preserving filtering comprises:
creating an illumination patch using an affine transform of a corresponding image patch;
determining one or more transform parameters based on the affine transform;
creating an illumination patch map using a plurality of image patches and the one or more transform parameters; and
integrating the illumination patch map to generate an illumination map.

7. The method of claim 1, wherein processing the enhanced image data for display includes performing one or more passthrough transformations to produce final view frames for display.

8. An electronic device comprising:
at least one processing device configured to:
obtain image data including an image frame having a plurality of pixels;
determine a scene lighting condition associated with the image data;
create an exposure ratio model based on the image data and the scene lighting condition;
create an image enhancement model using the exposure ratio model;
perform an image enhancement process on the image data using the image enhancement model to produce enhanced image data; and
process the enhanced image data for display on at least one display device.

9. The electronic device of claim 8, wherein the at least one processing device is further configured to:
create a camera response model using one or more parameters of at least one imaging sensor used to capture the image frame and camera color calibration; and
create a brightness transform model using the one or more parameters;
wherein the at least one processing device is configured to integrate the exposure ratio model, the camera response model, and the brightness transform model to create the image enhancement model.

10. The electronic device of claim 8, wherein the at least one processing device is configured to create the exposure ratio model using an illumination map and one or more parameters of at least one imaging sensor used to capture the image frame.

11. The electronic device of claim 8, wherein the at least one processing device is further configured to:
integrate the image enhancement model and the exposure ratio model to generate an integrated image enhancement model;
perform brightness enhancement on the image data using the integrated image enhancement model; and
perform contrast enhancement on the image data using the integrated image enhancement model.

12. The electronic device of claim 8, wherein the at least one processing device is further configured to:
create an exposure ratio map using the exposure ratio model, the exposure ratio map including an exposure ratio value for each of the pixels; and
perform edge preserving filtering on the exposure ratio map using one or more parameters of the exposure ratio model, wherein the image enhancement process incorporates the filtered exposure ratio map.

13. The electronic device of claim 12, wherein, to perform the edge preserving filtering, the at least one processing device is configured to:
create an illumination patch using an affine transform of a corresponding image patch;
determine one or more transform parameters based on the affine transform;
create an illumination patch map using a plurality of image patches and the one or more transform parameters; and
integrate the illumination patch map to generate an illumination map.

14. The electronic device of claim 8, wherein, to process the enhanced image data for display, the at least one processing device is configured to perform one or more passthrough transformations to produce final view frames for display.

15. A non-transitory machine readable medium containing instructions that when executed cause at least one processor of an electronic device to:
obtain image data including an image frame having a plurality of pixels;
determine a scene lighting condition associated with the image data;
create an exposure ratio model based on the image data and the scene lighting condition;
create an image enhancement model using the exposure ratio model;
perform an image enhancement process on the image data using the image enhancement model to produce enhanced image data; and
process the enhanced image data for display on at least one display device.

16. The non-transitory machine readable medium of claim 15, further containing instructions that when executed cause the at least one processor to:
create a camera response model using one or more parameters of at least one imaging sensor used to capture the image frame and camera color calibration; and
create a brightness transform model using the one or more parameters;
wherein the instructions when executed cause the at least one processor to integrate the exposure ratio model, the camera response model, and the brightness transform model to create the image enhancement model.

17. The non-transitory machine readable medium of claim 15, wherein the instructions when executed cause the at least one processor to create the exposure ratio model using an illumination map and one or more parameters of at least one imaging sensor used to capture the image frame.

18. The non-transitory machine readable medium of claim 15, further containing instructions that when executed cause the at least one processor to:
integrate the image enhancement model and the exposure ratio model to generate an integrated image enhancement model;
perform brightness enhancement on the image data using the integrated image enhancement model; and
perform contrast enhancement on the image data using the integrated image enhancement model.

19. The non-transitory machine readable medium of claim 15, further containing instructions that when executed cause the at least one processor to:
create an exposure ratio map using the exposure ratio model, the exposure ratio map including an exposure ratio value for each of the pixels; and
perform edge preserving filtering on the exposure ratio map using one or more parameters of the exposure ratio model, wherein the image enhancement process incorporates the filtered exposure ratio map.

20. The non-transitory machine readable medium of claim 19, wherein the instructions that when executed cause the at least one processor to perform the edge preserving filtering comprise instructions that when executed cause the at least one processor to:
create an illumination patch using an affine transform of a corresponding image patch;
determine one or more transform parameters based on the affine transform;
create an illumination patch map using a plurality of image patches and the one or more transform parameters; and
integrate the illumination patch map to generate an illumination map.
